(19) United States
(12) Patent Application Publication
(10) Pub. No.: US 2010/0131447 A1
(43) Pub. Date: May 27, 2010

(54) Method, Apparatus and Computer Program Product for Providing an Adaptive Word Completion Mechanism

(75) Inventors: Mathias Johan Philip Creutz, Helsinki (FI); Sunil Sivadas, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/323,945

(22) Filed: Nov. 26, 2008

(51) Int. Cl. G06N 7/02

(52) U.S. Cl. 706/52

(57) ABSTRACT

An apparatus for providing an adaptive word completion mechanism may include a processor. The processor may be configured to receive an indication of an input character corresponding to a word being entered, determine a situation profile corresponding to entry of the word, utilize a processor to adjust a probability of candidate words for completing the word being entered based at least in part on the situation profile, and provide at least one suggested word completion option to a user.

### TECHNOLOGICAL FIELD

Embodiments of the present invention relate generally to user interface technology and, more particularly, relate to a method, apparatus and computer program product for providing an adaptive word completion mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some situations, it may be desirable for the user to interface with a device such as a mobile terminal for the provision of an application or service. As such, a user interface may be provided to enable receipt of user input at the device and provision of output to the user. The user interface may be utilized for text input, for selection of commands, options, hotspots, etc., and for numerous other functions. A typical user interface may include a keyboard including keys that may be pressed or selected in order to provide character entry. The keyboard may be physically embodied, for example, as a plurality of keys having a predefined function associated therewith, or may be embodied in software (e.g., via a touch screen or a keyboard rendered on a display with keys selectable by mouse or scrolling device). However, regardless of whether a touch screen, rendered keyboard or physical keyboard is utilized, for certain electronic devices in which the size of the device may be limited for practical or personal reasons, it may be difficult to provide text entry in an efficient or expeditious manner. Accordingly, improvements for a word input mechanism may be desirable.

### BRIEF SUMMARY

A method, apparatus and computer program product are therefore provided to enable the provision of an adaptive word completion mechanism. In this regard, some embodiments of the present invention may provide a word input mechanism that is adaptable to user behavior. For example, some embodiments of the present invention may be tailored to provide candidates for completion of words for which at least one character is entered in light of past behavior of specific users and/or situations.

In an exemplary embodiment, a method of providing an adaptive word completion mechanism is provided. The method may include receiving an indication of an input character corresponding to a word being entered, determining a situation profile corresponding to entry of the word, utilizing a processor to adjust a probability of candidate words for completing the word being entered based at least in part on the situation profile, and providing at least one suggested word completion option to a user.

In another exemplary embodiment, a computer program product for providing an adaptive word completion mechanism is provided. The computer program product includes at least one computer-readable storage medium having computer-executable program code instructions stored therein. The computer-executable program code instructions may include program code instructions receiving an indication of an input character corresponding to a word being entered, determining a situation profile corresponding to entry of the word, utilizing a processor to adjust a probability of candidate words for completing the word being entered based at least in part on the situation profile, and providing at least one suggested word completion option to a user.

In another exemplary embodiment, an apparatus for providing an adaptive word completion mechanism is provided. The apparatus may include a processor. The processor may be configured to receive an indication of an input character corresponding to a word being entered, determine a situation profile corresponding to entry of the word, utilize a processor to adjust a probability of candidate words for completing the word being entered based at least in part on the situation profile, and provide at least one suggested word completion option to a user.

In another exemplary embodiment, an apparatus for providing an adaptive word completion mechanism is provided. The apparatus may include means for receiving an indication of an input character corresponding to a word being entered, means for determining a situation profile corresponding to entry of the word, means for utilizing a processor to adjust a probability of candidate words for completing the word being entered based at least in part on the situation profile, and means for providing at least one suggested word completion option to a user.

Embodiments of the invention may provide a method, apparatus and computer program product for employment in mobile environments, such as on a mobile terminal capable of rendering content items related to various types of media, and in fixed environments. As a result, for example, users may enjoy an improved user interface capability and a corresponding improved ability to input text for communication, work product generation, entertainment, instructional or other purposes.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing a word input mechanism according to an exemplary embodiment of the present invention;

FIG. 3 illustrates a flow diagram of a word prediction process that may incorporate situation awareness according to an exemplary embodiment of the present invention;

FIG. 4 illustrates an example of how sensor data may be used by a situation determiner to create situation profiles and a word list including n-grams in accordance with an exemplary embodiment of the present invention;

FIG. 5 shows a block diagram illustrating how words with associated probabilities may be associated with corresponding situation profiles in accordance with an exemplary embodiment of the present invention;

FIG. 6 shows a block diagram illustrating a mechanism for keeping track of probabilities of words when the context of previous words is known according to an exemplary embodiment of the present invention;

FIG. 7 shows a block diagram illustrating an exemplary prediction scenario based on the generated products from FIGS. 4-6 according to an exemplary embodiment of the present invention;

FIG. 8 shows a block diagram illustrating an example of a word prediction algorithm including speech input; and

FIG. 9 is a flowchart according to an exemplary method for providing a user behavior adaptable word input mechanism according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

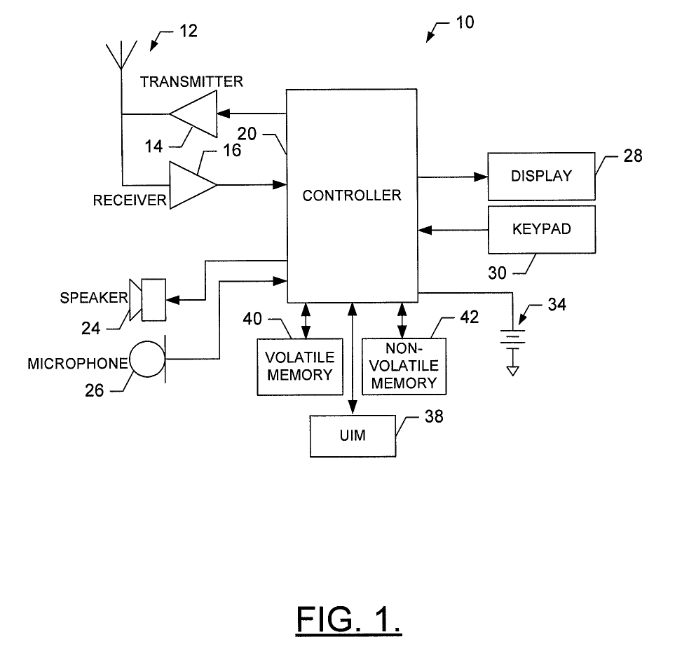

FIG. 1 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, global positioning system (GPS) devices, mobile telephones any combination of the aforementioned, and/or other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennas) in operable communication with a transmitter 14 and a receiver 16. The mobile terminal 10 may further include an apparatus, such as a controller 20 or other processing element, that may provide signals to and receive signals from the transmitter 14 and receiver 16, respectively. The signals may include signaling information in accordance with the air interface standard of the applicable cellular system, and/or may also include data corresponding to speech, received data and/or user generated/transmitted data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved-universal terrestrial radio access network), with fourth-generation (4G) wireless communication protocols and/or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 20 may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional web browser. The connectivity program may then allow the mobile terminal 10 to transmit and receive web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a microphone 26, a display 28, and a user input interface, which may be operationally coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include numeric (0-9) and related keys (#, *), and other hard and soft keys used for operating the mobile terminal 10. Alternatively, the keypad 30 may include a QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 can additionally or alternatively comprise an electrically erasable programmable read only memory (EEPROM), flash memory, other non-volatile RAM (NVRAM) or the like. Non-volatile memory 40 may also include a cache area for the temporary storage of data. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

Although an exemplary embodiment of the present invention described below will generally refer to word lists and/or selection of words in relation to presentation and/or selection of candidate words from among a plurality of candidate words provided in a candidate word field or list, embodiments of the present invention more generally relate to any application in which a text entry may be provided relating to a plurality of characters comprising a recognizable communicative element. As such, whenever a text entry of characters, such as a number, letter, symbol or the like, is to be performed, embodiments of the present invention may be practiced. Accordingly, when the terms “word” or “words” are used herein, they should be understood to include character sequences that may or may not be present in a dictionary including, for example, names, phrases, slang, abbreviations, emoticons, acronyms, etc.

Embodiments of the present invention may involve a presentation and/or selection of selected candidate words from among a plurality of candidate words in a candidate word field that may resemble a listing of words. However, other mechanisms for presenting candidate words may also be employed. For example, a word cloud, a pop up window, a semi-transparent overlay, or even a single word guess may also be employed, among other potential display options. As such, when a candidate word or a plurality of candidate words are selected for presentation to the user as a potential word based on current input and the present situation (e.g., via a situation profile), as described below, any of numerous display options may be further employed to present the selected candidate word(s) to the user for potential selection to obviate a need to enter each and every character of the selected candidate word(s). Selection of a particular candidate word by the user may then provide that the selected candidate word is included in a text field (e.g., for inclusion in a message, instruction, etc.) rendered on a display screen. Accordingly, the user may not be required to enter each individual character of the selected candidate word. The selected candidate words may be determined based on any of a number of factors that may provide flexibility for adapting candidate words to be presented to the user to the current conditions as may be determinable from numerous factors such as historical, situation, contextual and/or statistical factors. The factors may be clues related to the usage of words by a particular user in particular situations. Thus, when a current situation is recognized as corresponding to a previously encountered situation, a situation profile associated with the previously encountered situation may be employed to provide a probabilistic determination of the words that may be likely to be used in the current situation based on the situation profile. For each character entry, the entered character and/or character sequence may be used to pare down the list of selected candidate words to be presented to the user until such time as the text entry is completed or the user selects one of the candidate words presented.

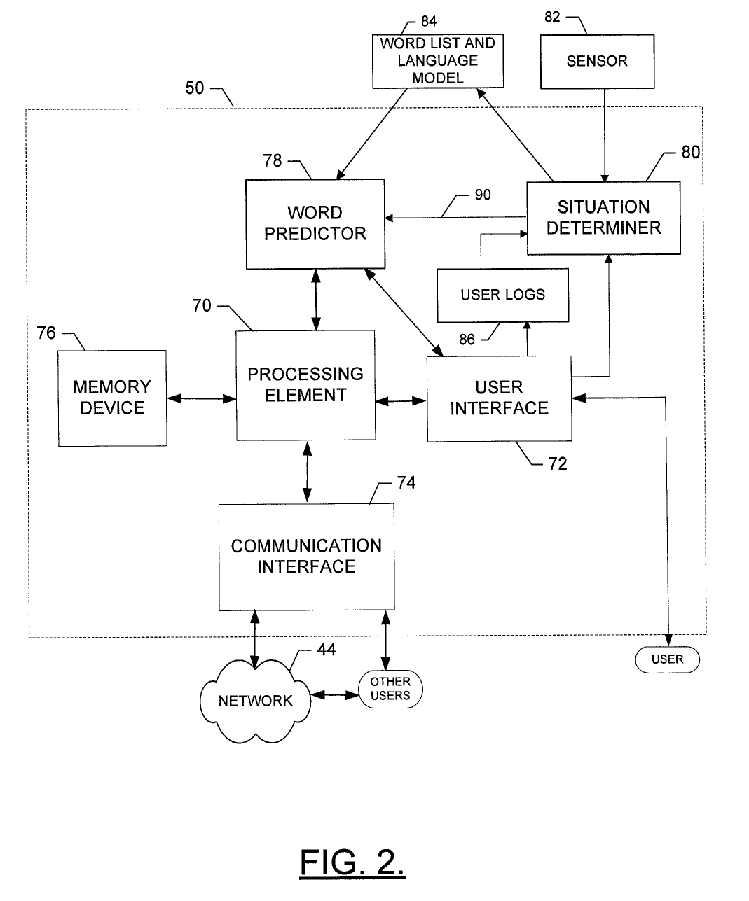

The situation factors or clues may be determined from the application associated with the text entry (e.g., email, short message, word processor, web browser, etc.), from a history of user behavior (e.g., call logs, web sites visited, calendar data, positional history, application usage, sent/received messages (e.g., short message service (SMS) messages, etc.), from positional information (e.g., user location by GPS, near field communication sensors (e.g., barcodes or radio frequency identification (RFID) tags, camera data, or other methods), or from other situation factors (e.g., frequency, user habits, type of message, other like factors or combinations of the preceding) related to the application. In this regard, certain candidate words may be more likely to be used in certain situations than in others (e.g., the use of “hello” or “hi” may be a predictable opening to an email or short message) and thus, may be presented as candidate words in situations where the likelihood of their use is above a particular threshold. The user's own style and past usage of words in certain situations may also provide contextual clues that may form the basis of determining candidate words. In this regard, for example, a likelihood of various subsequent words (e.g., likely word followers) may be determined based on prior selections made by the user, and more particularly, based on prior selections in consideration of the situation at the time of such selections. Moreover, candidate words may be differentiated from each other also based on the relative likelihood (e.g., probability) of each particular candidate word being the next word selected based on the previous word, a currently selected letter or sequence of letters, or other contextual clues. As such, some embodiments of the present invention may provide for determinations regarding word usage/frequency on an application and/or situation basis. Moreover, the provision of such determinations may be provided by an exemplary embodiment that will now be described in relation to the example apparatus illustrated in FIG. 2.

FIG. 2 illustrates a schematic block diagram of an apparatus for enabling user behavior adapted word completion according to an exemplary embodiment of the present invention. An exemplary embodiment of the invention will now be described with reference to FIG. 2, in which certain elements of an apparatus 50 for enabling user behavior adapted word completion are displayed. The apparatus 50 of FIG. 2 may be employed, for example, on the mobile terminal 10 of FIG. 1. However, the apparatus 50 may alternatively be embodied at a variety of other devices, both mobile and fixed (such as, for example, a network device or server). As such, while some embodiments of the present invention may be embodied wholly at a single device (e.g., the mobile terminal 10), other embodiments may be split between devices in a client/server relationship (e.g., the mobile terminal 10 and a network server). Furthermore, it should be noted that the devices or elements described below may not be mandatory and thus some may be omitted in certain embodiments. Additional elements could also be added in some cases.

Referring now to FIG. 2, the example apparatus 50 for enabling user behavior adapted word completion may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network (e.g., network 44) and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet and/or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated.

The network 44 may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network 44. Although not necessary, in some embodiments, the network 44 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 (which may include the apparatus 50) may be in communication with each other via the network 44 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the apparatus 50 via the network 44. By directly or indirectly connecting the apparatus 50 and other devices to the network 44, the apparatus 50 may be enabled to communicate with the other devices, for example, according to numerous communication protocols including Hypertext Transfer Protocol (HTTP) and/or the like, to thereby carry out various communication or other functions of the apparatus 50.

In an exemplary embodiment, the processor 70 of the apparatus 50 may be embodied as, include or otherwise control a word predictor 78 and a situation determiner 80. As such, the word predictor 78 and the situation determiner 80 may in some cases each be separate devices, modules, or functional elements. However, in other embodiments, the word predictor 78 and the situation determiner 80 may be embodied within a single device, module, or functional element, such as the processor 70, the apparatus 50 or the mobile terminal 10. The word predictor 78 and the situation determiner 80 may each be any means such as a device or circuitry embodied in hardware, software or a combination of hardware and software (e.g., processor 70 operating under software control) that is configured to perform the corresponding functions of the word predictor 78 and the situation determiner 80, respectively, as described below. In some embodiments, communication between the word predictor 78 and the situation determiner 80 may be conducted via the processor 70. However, the word predictor 78 and the situation determiner 80 may alternatively be in direct communication with each other.

In an exemplary embodiment, the word predictor 78 and the situation determiner 80 may include instructions, code, modules, applications and/or circuitry for providing word prediction and situation determining services, respectively. However, it should be noted that code, circuitry and/or instructions associated with the word predictor 78 and/or the situation determiner 80 need not necessarily be modular.

In an exemplary embodiment, the apparatus 50 may further include or otherwise be capable of communication with any or all of a sensor 82, a word list and language model 84 and a user log 86. The sensor 82 may include one or more of a near field communication sensor (e.g., barcode or RFID), a microphone, a clock or other time sensor, a location sensor (e.g., GPS or assisted GPS (A-GPS)), a camera, and/or the like. In this regard, the sensor 82 may be configured to provide the situation determiner 80 with information about a current position, time, context or other information that may be useful in determining the current situation of the apparatus 50.

The word list and language model 84 may include a listing of candidate words that may be presented to the user as candidate words by the word predictor 78. The language model portion of the word list and language model 84 may provide a probability associated with word usage in the context of other words (e.g., likely word followers, likely word combinations, and/or the like). In some cases, the word list and language model 84 may be stored in the memory device 76. However, the word list and language model 84 could alternatively be stored at another location accessible by the situation determiner 80 and the word predictor 78. In some embodiments, the word list and language model 84 may include a basic word list including, for example, a dictionary or other listing of basic or commonly used words. The basic word list may then be modified and/or the word list and language model 84 may include added words based on word usage indicated by the user log 86 for a particular situation.

The user log 86 may include historical information about user actions and may also include calendar information useful for determining user context so that context information (e.g., in information indicating that the user plans to be in a particular meeting, on a vacation, at a particular location, or other appointments or planned events) may be stored and/or provided to the situation determiner 80 for use in determining a situation profile of various situations. The user log 86 may store call history, sent and/or received messages (e.g., including SMS messages, email, etc.), visited web sites, filled out forms, and/or the like.

The situation determiner 80 may be configured to receive information from the user log 86, the sensor 82 and/or the user interface 72 in order to determine a current situation profile of the user and communicate the situation profile to the word predictor 78 as indicated by arrow 90 in FIG. 2. In an exemplary embodiment, the sensor 82 may provide information on current location, time, and/or other physical information about the user that may be useful in determining the user's current situation profile. Meanwhile, the user interface 72 may provide information on which field of a particular web page, document, form, application or the like is to be filled. The user interface 72 may also provide information on preceding words, characters or phrases.

The user log 86 may also provide information to the situation determiner 80 that may be useful in determining the user's current situation profile. In this regard, for example, the user log 86 may indicate calendar information to enable correlation between the current location and time and an event associated with the current location and time. The user log 86 may also provide historical information on past events, user actions, word usage and the situations in which various words were used based on logged information. The historical information may be used by the situation determiner 80 for generating situation profiles indicative of word usage of the user in particular situations. Accordingly, for example, the situation determiner 80 may use information regarding the current conditions (e.g., from the sensor 82 and the user interface 72) and past situations (e.g., from the user log 86) to determine a current situation profile by comparing conditions of stored situation profiles to current conditions to define the current situation profile as the situation profile having conditions that most closely match the current conditions. The situation determiner 80 may then communicate the current situation profile to the word predictor 78. Thus, for example, word usage, frequency of usage of particular words, frequency of the usage of particular words in corresponding particular situations or with particular applications and other statistical information about the user may be used to generate situation profiles that may augment probability determinations made by the word predictor 78 as described herein.

The word predictor 78 may be configured to provide one or more candidate words to the user interface 72 as a suggested or recommended word based on the entry of one or more characters. In this regard, for example, the word predictor 78 may use probabilistic determinations such as likely word followers for preceding words, and likely letter followers for preceding letters as a basis for suggesting a candidate word based on at least one entered character received from the user interface 72 (e.g., via a keyboard, keypad or touch screen entry). However, in accordance with some embodiments of the present invention, the word predictor 78 may alternatively or additionally provide for determining or adjusting probability rankings for candidate words according to a current situation profile.

Thus, for example, the word predictor 78 may provide that the probability for a particular word corresponding to a previously entered character or characters may be determined based at least in part on a situation profile determined for the current situation. The word predictor 78 may further provide for a presentation (e.g., at the user interface 72) of one or more candidate words based on the determined probability of the one or more candidate words completing a word currently being entered at the user interface 72. As such, words provided from the word list and language model may be considered by the word predictor 78 based on the current situation profile and the character or characters previously entered. Moreover, after a particular word is completed (e.g., either by full entry of each character or by selection of a candidate word) the situation determiner 80 may receive an indication from the user interface 72 of the completed word and record the completed word's usage in the current situation profile. Accordingly, the situation profile corresponding to the current situation may be updated so that dynamic updating of the situation profiles may provide for continued learning (and consequently hopefully a better understanding) of the words likely to be used by a particular user in particular situations.

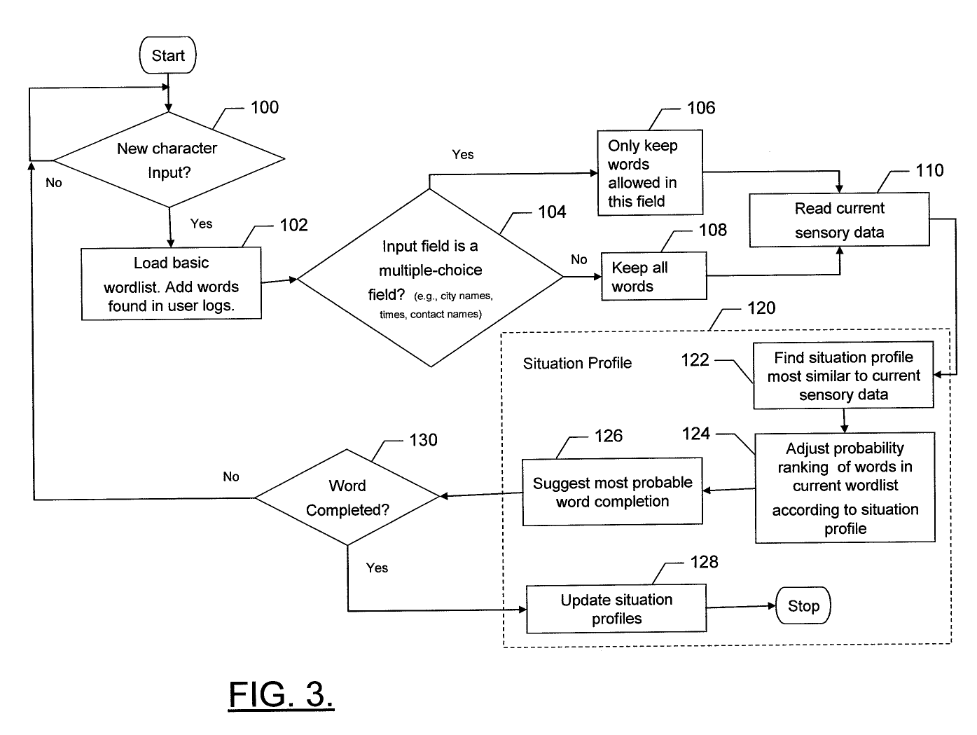

FIG. 3 illustrates a flow diagram of a word prediction process that may incorporate situation awareness according to an exemplary embodiment. In this regard, as shown in FIG. 3, a determination may be made as to whether new character has been input at operation 100. If a new character (either a first character or subsequent character) has been input, a word list and language model may initially be consulted at operation 102. In some embodiments, as shown in the example of FIG. 3, the word list and language model may include a basic word list that may include modifications made based on information received from the user log 86. At operation 104, a determination may be made as to whether a particular input field is a multiple choice or other field having limited possible entries (e.g., a city name, time, contact name or similar field). If the field is a field that has limited possible entries that are allowed, the word list and language model may be modified to exclude words that are not allowed in the field at operation 106. If the field is not a field that has limited possible entries that are allowed, the word list and language model may be left unmodified at operation 108. At operation 110, current sensor data may be consulted or read. The current sensor data may be used to determine a situation profile at operation 120 that may be employed for predicting completion of the word corresponding to the new character. If the word is not completed (e.g., via selection of the predicted word or by completion of text entry) at operation 130, then operation may continue by waiting for receipt of a new character at operation 100.

In an exemplary embodiment, operation 120 may include sub-operations as described below. In particular, at operation 122, a situation profile most similar to the current sensory data may be determined (e.g., by the situation determiner 80). The probability ranking of words in the word list and language model may then be adjusted or modified by the word predictor 78 based on the current situation profile at operation 124. The word predictor 78 may then suggest one or more candidate words that are considered likely to complete the word corresponding to the new character input at operation 126. The suggested candidate word or words may be all or a portion of the remaining candidate words after modification according to allowed words (e.g., for the given field, if any, and/or for the current character sequence) and/or modification according to the current situation profile. Alternatively, one or more of the highest ranked (e.g., most likely) words may be provided as a suggestion for word completion. Additionally, in some embodiments, if the word is determined to be completed at operation 130, the situation determiner 80 may be further configured to update the situation profiles at operation 128.

In some embodiments, more specific implementation details may be included, some examples of which are described below. In an exemplary embodiment, the situation determiner 80 may be configured to employ an unsupervised clustering algorithm to discover “situations” of the user. In this regard, situations of the user may include information such as the location, time and action (e.g., opening a web page, starting to write an SMS, and/or the like) of the user. In some cases, the clustering performed by the situation determiner 80 may provide that the user's situation is generalized instead of provided with specificity. For example, if the user's location is provided in specific GPS coordinates and in time to the nearest second for the performance of a particular action, the situation determiner 80 may be configured to generalize that the specific GPS coordinates correspond to the user's home and the time generally corresponds to evening time. Thus, the user's situation may be defined as being at home in the evening rather than being given with specific coordinates and time. The situation determiner 80 may record word usage statistics in association with each or a plurality of situations that may be generalized as described above. As such, for example, the situation determiner 80 may determine a situation profile for each situation that includes a situation-specific weighting for each word.

In an exemplary embodiment, as indicated above, each time the user starts to enter new data, the current situation may be matched with the most similar situation profile and, for the new data entered, the situation-specific probability for various possible word completion scenarios for the data entered may be retrieved and/or provided. When the user has completed an action (e.g., completing text entry of a word, or selecting a candidate word to complete a text entry), the situation determiner 80 may use the completed action in the corresponding situation in order to improve performance in the future. As such, clustering and probabilities determined by the situation determiner 80 and/or word predictor 78 may be updated. In some cases, clustering and probabilities determined may be updated by maximum a posteriori adaptation or some other statistical adaptation method. In some cases, time stamps and/or locations explicitly provided in the user log 86 (e.g., a calendar entry defining a meeting at a particular date and time) may be given priority over automatically learned clusters.

Updating or adaptation of situation profiles may be performed by many different mechanisms. In an example case, a statistical topic language model may be employed. In this regard, for example, conditional probabilities (e.g., P(word|specific_situation) may be established (and updated) for various different words. Thus, for example, when the topic “school” is established, a corresponding vocabulary may be selected as a word list. In some instances, it may be challenging to infer useful situations in an unsupervised manner. In an exemplary embodiment, situation space may be divided into segments such that each segment corresponds to a relevant topic from the point of view of language modeling (e.g., “at work in the office”, “working at home”, “on vacation at the cottage”, etc.). Updating may take place using maximum a posteriori optimization. In this regard, for example, a cost function (e.g., that may be maximized) may include previous actions involving text input. Accordingly, hindsight may be used to determine (or maximize) a probability over past actions, such that the best word prediction could have been achieved. Model complexity may be controlled using a prior distribution on the number of clusters. For clustering, robust methods such as principle component analysis (PCA), independent component analysis (ICA), self-organizing map (SOM), or other exemplary clustering mechanisms may be employed.

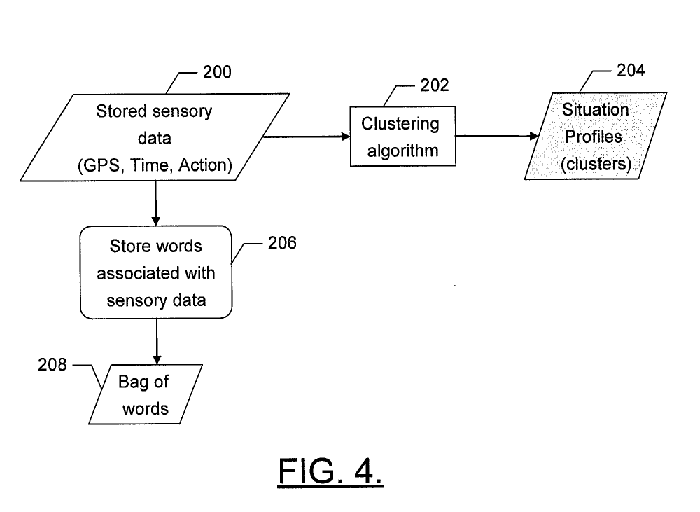

In some exemplary embodiments, the word list and language model 84 may include n-grams instead of or in addition to actual words. FIGS. 4-7 illustrate further examples of block diagrams of embodiments of the present invention in which n-grams or words may be utilized. FIG. 4 illustrates an example of how sensor data may be used by the situation determiner 80 to create situation profiles and a word list including n-grams. In this regard, stored sensor data 200 may initially be received and/or analyzed. At operation 202, a clustering algorithm may be applied to cluster similar sensory data. The similar sensory data (e.g., clusters) may then be formed into situation profiles 204. Words or n-grams may also be stored in association with corresponding sensory data at operation 206 in order to create the word list or n-gram list 208.

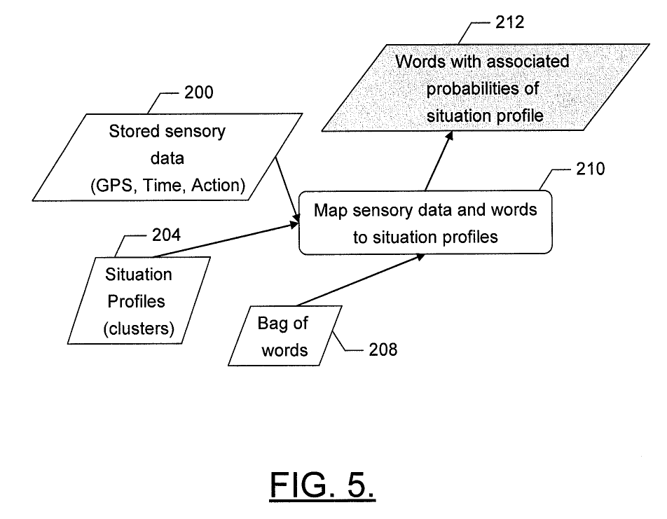

FIG. 5 shows a block diagram illustrating how words with associated probabilities may be associated with corresponding situation profiles. In this regard, for example, the stored sensory data 200, the situation profiles 204, and the n-gram list may be received to enable mapping of the sensory data and n-grams or words to the situation profiles at operation 210. A result of the mapping may be words or n-grams in a map of associated probabilities of respective situation profiles 212. Accordingly, words may be associated with particular situation profiles.

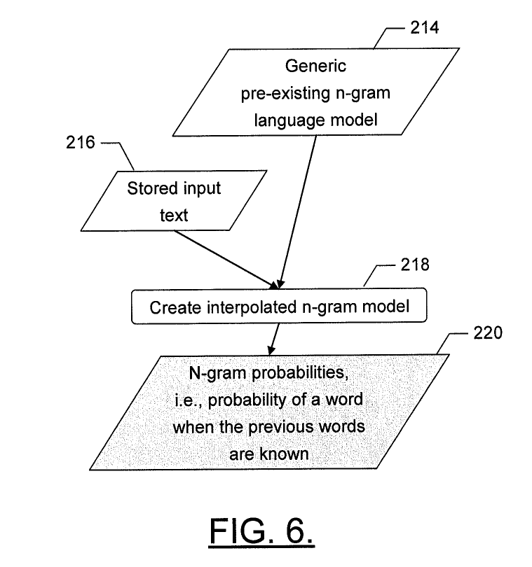

FIG. 6 shows a mechanism for keeping track of probabilities of words when the context of previous words is known. A database of probabilities according to FIG. 6 may be independent from the situation specific probabilities of words or n-grams. As shown in FIG. 6, a generic pre-existing word or n-gram language model 214 may provide initial modeling data. Stored input text 216 may also be used as an input for modeling. An interpolated n-gram model may then be created at operation 218 based on the stored input text 216 and the pre-existing word or n-gram language model 214 in order to produce n-gram probabilities 220. The n-gram probabilities may define a probability of a particular word when the previous word or words are known.

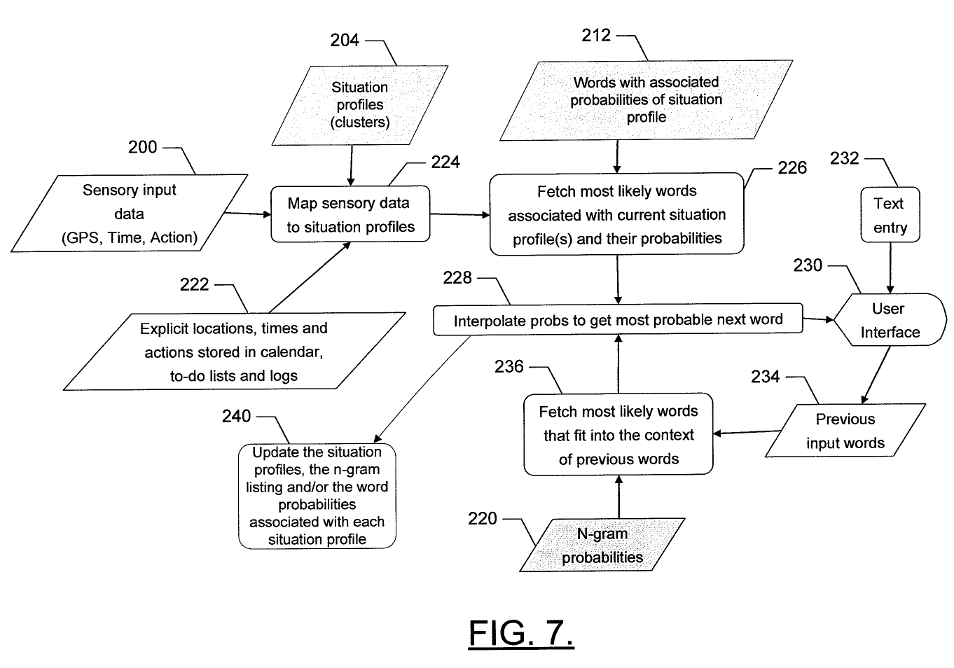

FIG. 7 shows an exemplary prediction scenario based on the generated products from FIGS. 4-6. In this regard, the stored sensory data 200 may be received along with situation profiles 204 and explicit locations, times and actions 222 (e.g., from calendar, to-do lists, logs, etc.) to enable mapping of sensory data to situation profiles at operation 224. Input from logs or sensors may be weighted differently in case of conflicts that may be inferred between data from the two sources. Additionally, some data may be considered equivalent in sensor and log or other historical information (e.g., a GPS location of a particular city may be considered equivalent to the city name). The map of words or n-grams with associated probabilities of respective situation profiles 212 may then be incorporated to enable fetching of most likely words associated with a current situation profile and the respective probabilities of the most likely words at operation 226. An interpolation of the probabilities may then be performed to determine the most probable next word at operation 228. The most probable next word (or a listing of words) may then be provided to the user interface at operation 230. Based on text entry information 232 (e.g. character entry information), previous input words 234 may be determined and a most likely word or words that fit into the context of previous words may be determined at operation 236 in further consideration of n-gram probabilities 220 in order to again provide an interpolation of the probabilities to determine an updated most probable word completion or next word at operation 228. Updating of the situation profiles, the n-gram listing and/or the word probabilities associated with each situation profile may then be accomplished at operation 240. Each update may be performed independent of each other or in a single updating operation.

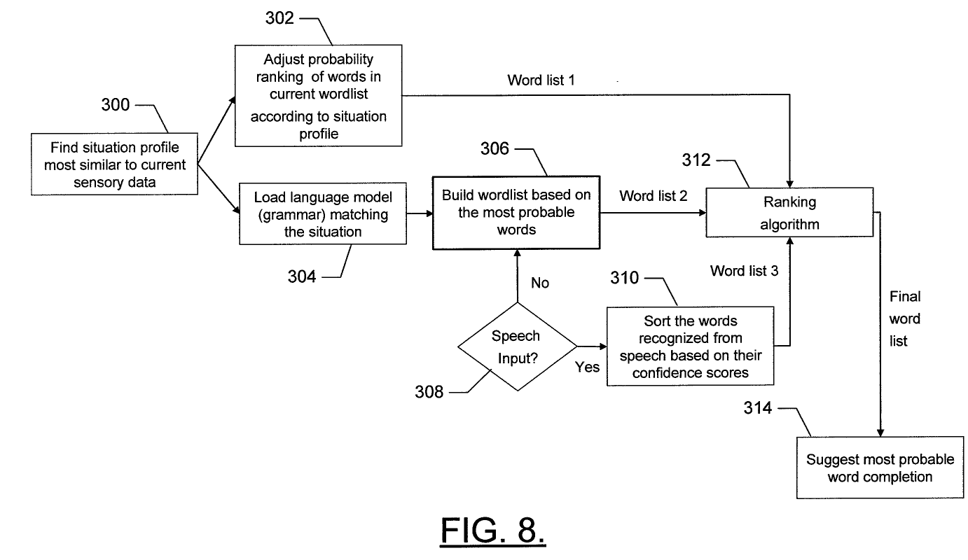

As indicated above in FIG. 3, an example of the sensor 82 may include a microphone. Thus, in some embodiments, speech input may be included in a word prediction algorithm according to exemplary embodiments of the present invention. FIG. 8 illustrates an example of a word prediction algorithm including speech input. In this regard, as shown in FIG. 8, a situation profile may be found that is most similar to the current sensory data at operation 300. The probability rankings of words in the current word list may be adjusted according to the situation profile at operation 302 to generate a first word list. Additionally, a language model (e.g., a grammar model) matching the current situation may be loaded at operation 304. A second word list may be built based on the most probable words according to the language model at operation 306 if there is no speech input. If there is a speech input at operation 308, then recognized words corresponding to the speech input may be sorted according to their respective confidence scores at operation 310 to provide a third word list. The first, second and third word lists may each be ranked by a ranking algorithm at operation 312 in order to produce a final word list that may be used for suggesting a probable word completion at operation 314 as described above. Notably, although this example shows the first, second and third word lists being separately formed and ranked at operation 312, alternative embodiments may provide for modification and/or combination of word lists in any order. Thus, the word lists may be combined in a cascaded fashion, in parallel, according to various combinations of parallel and cascaded operations, or by other mechanisms.

Accordingly, some embodiments of the present invention provide an improved capability for word completion. In this regard, in an example embodiment, the probability of each candidate word completing a word being entered, as indicated by a character entry, is adjustable based on the current situation. As such, in some embodiments, a situation profile defining actions occurring under certain temporal conditions at a corresponding location is employed to improve the quality of suggestions provided for word completion by adjusting probabilistic determinations made regarding candidate words for completing a text entry to provide a word completion mechanism that has situational awareness.

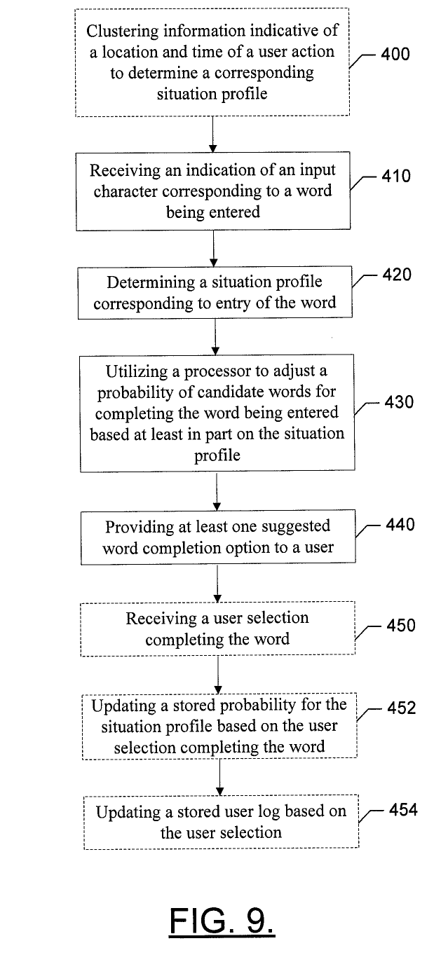

FIG. 9 is a flowchart of a system, method and program product according to exemplary embodiments of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal (or a network device) and executed by a built-in processor in the mobile terminal (e.g., the processor 70) (or a network device). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart may support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

In this regard, one embodiment of a method for providing a user behavior adaptable word input mechanism as illustrated, for example, in FIG. 9 may include receiving an indication of an input character corresponding to a word being entered at operation 410 and determining a situation profile (e.g., including temporal information, location information and information defining an action undertaken that the corresponding time and location defined by the temporal information and the location information) corresponding to entry of the word at operation 420. The method may further include utilizing a processor to adjust a probability of candidate words for completing the word being entered based at least in part on the situation profile at operation 430 and providing at least one suggested word completion option to a user at operation 440.

In some embodiments, the method may include further optional operations, some examples of which are shown in dashed lines in FIG. 9. Optional operations may be performed in any order and/or in various combinations with each other and the other operations in various alternative embodiments. As such, the method may further include operations of clustering information indicative of a location and time of a user action to determine a corresponding situation profile at operation 400. In some cases, the method may include receiving a user selection completing the word at operation 450. In such cases, the method may further include updating a stored probability for the situation profile based on the user selection completing the word at operation 452 and/or updating a stored user log based on the user selection at operation 454, which may include updating the situation profile.

In some embodiments, certain ones of the operations above may be modified or further amplified as described below. It should be appreciated that each of the modifications or amplifications below may be included with the operations above either alone or in combination with any others among the features described herein. In this regard, for example, determining the situation profile may include comparing sensor data currently or more recently received to previously received sensor data and determining the situation profile to be a stored situation profile having sensor data that most closely matches the sensor data currently or more recently received. Meanwhile, adjusting the probability of candidate words may include determining whether a field in which the word is being entered has limited word options and eliminating options from the candidate words that are not possible entries for the field, adjusting a probability of a particular word following a previously entered word based at least in part on a probability of the particular word being used in the situation profile, and/or adjusting a probability of a particular word matching a recognized spoken word based at least in part on a probability of the particular word being used in the situation profile.

In an exemplary embodiment, an apparatus for performing the method of FIG. 9 above may comprise a processor (e.g., the processor 70) configured to perform some or each of the operations (400-454) described above. The processor may, for example, be configured to perform the operations (400-454) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-454 may comprise, for example, the processor 70, the word predictor 78, the situation determiner 80, and/or an algorithm executed by the processor 70 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of an input character corresponding to a word being entered;
determining a situation profile corresponding to entry of the word;
utilizing a processor to adjust a probability of candidate words for completing the word being entered based at least in part on the situation profile; and
providing at least one suggested word completion option to a user.

2. The method of claim 1, wherein determining the situation profile comprises comparing sensor data more recently received to previously received sensor data and determining the situation profile to be a stored situation profile having sensor data that most closely matches the sensor data more recently received.

3. The method of claim 1, wherein adjusting the probability of candidate words further comprises determining whether a field in which the word is being entered has limited word options and eliminating options from the candidate words that are not possible entries for the field.

4. The method of claim 1, wherein adjusting the probability of candidate words further comprises adjusting a probability of a particular word following a previously entered word based at least in part on a probability of the particular word being used in the situation profile.

5. The method of claim 1, wherein adjusting the probability of candidate words further comprises adjusting a probability of a particular word matching a recognized spoken word based at least in part on a probability of the particular word being used in the situation profile.

6. The method of claim 1, further comprising clustering information indicative of a location and time of a user action to determine a corresponding situation profile.

7. The method of claim 1, further comprising receiving a user selection completing the word.

8. The method of claim 7, further comprising updating a stored user log based on the user selection.

9. The method of claim 7, further comprising updating a stored probability for the situation profile based on the user selection completing the word.

10. A computer program product comprising at least one computer-readable storage medium having computer-executable program code instructions stored therein, the computer-executable program code instruction comprising:
program code instructions for receiving an indication of an input character corresponding to a word being entered;
program code instructions for determining a situation profile corresponding to entry of the word;
program code instructions for adjusting a probability of candidate words for completing the word being entered based at least in part on the situation profile; and
program code instructions for providing at least one suggested word completion option to a user.

11. The computer program product of claim 10, wherein program code instructions for determining the situation profile include instructions for comparing sensor data more recently received to previously received sensor data and determining the situation profile to be a stored situation profile having sensor data that most closely matches the sensor data more recently received.

12. The computer program product of claim 10, wherein program code instructions for adjusting the probability of candidate words include instructions for determining whether a field in which the word is being entered has limited word options and eliminating options from the candidate words that are not possible entries for the field.

13. The computer program product of claim 10, wherein program code instructions for adjusting the probability of candidate words include instructions for adjusting a probability of a particular word following a previously entered word based at least in part on a probability of the particular word being used in the situation profile.

14. The computer program product of claim 10, wherein program code instructions for adjusting the probability of candidate words include instructions for adjusting a probability of a particular word matching a recognized spoken word based at least in part on a probability of the particular word being used in the situation profile.

15. The computer program product of claim 10, further comprising program code instructions for clustering information indicative of a location and time of a user action to determine a corresponding situation profile.

16. The computer program product of claim 10, further comprising program code instructions for receiving a user selection completing the word.

17. The computer program product of claim 16, further comprising program code instructions for updating a stored user log based on the user selection.

18. The computer program product of claim 16, further comprising program code instructions for updating a stored probability for the situation profile based on the user selection completing the word.

19. An apparatus comprising a processor configured to:
receive an indication of an input character corresponding to a word being entered;
determine a situation profile corresponding to entry of the word;
adjust a probability of candidate words for completing the word being entered based at least in part on the situation profile; and
provide at least one suggested word completion option to a user.

20. The apparatus of claim 19, wherein the processor is configured to determine the situation profile by comparing sensor data more recently received to previously received sensor data and determining the situation profile to be a stored situation profile having sensor data that most closely matches the sensor data more recently received.

21. The apparatus of claim 19, wherein the processor is configured to adjust the probability of candidate words by determining whether a field in which the word is being entered has limited word options and eliminating options from the candidate words that are not possible entries for the field.

22. The apparatus of claim 19, wherein the processor is configured to adjust the probability of candidate words by adjusting a probability of a particular word following a previously entered word based at least in part on a probability of the particular word being used in the situation profile.

23. The apparatus of claim 19, wherein the processor is configured to adjust the probability of candidate words by adjusting a probability of a particular word matching a recognized spoken word based at least in part on a probability of the particular word being used in the situation profile.

24. The apparatus of claim 19, wherein the processor is further configured to cluster information indicative of a location and time of a user action to determine a corresponding situation profile.

25. The apparatus of claim 19, wherein the processor is further configured to receive a user selection completing the word.

26. The apparatus of claim 25, wherein the processor is further configured to update a stored user log based on the user selection.

27. The apparatus of claim 25, wherein the processor is further configured to update a stored probability for the situation profile based on the user selection completing the word.

28. An apparatus comprising:
means for receiving an indication of an input character corresponding to a word being entered;
means for determining a situation profile corresponding to entry of the word;
means for utilizing a processor to adjust a probability of candidate words for completing the word being entered based at least in part on the situation profile; and
means for providing at least one suggested word completion option to a user.

29. The apparatus of claim 28, further comprising means for clustering information indicative of a location and time of a user action to determine a corresponding situation profile.
